(19) United States
(12) Patent Application Publication
(10) Pub. No.: US 2006/0007194 A1
(43) Pub. Date: Jan. 12, 2006

(54) Transflective liquid crystal display with reduced flicker

(75) Inventors: Alwin Rogier Martijn Verschueren, Eindhoven (NL); Mark Thomas Johnson, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.C., BA Eindhoven (NL)

(21) Appl. No.: 10/527,431

(22) PCT Filed: Aug. 5, 2003
(86) PCT No.: PCT/IB03/03378

§ 371 Date: Mar. 9, 2005

(30) Foreign Application Priority Data
Sep. 12, 2002 (EP) 02078762.8

(51) Int. Cl. G09G 5/00

(52) U.S. Cl. 345/204; 345/102

(57) ABSTRACT

A method of reducing visible flicker in a transflective display device, having a plurality of pixels, each pixel comprising a transmissive sub-pixel and a reflective sub-pixel, is disclosed. The method comprises the steps of: driving the pixels with an alternating voltage; determining a first desired compensation voltage for the transmissive sub-pixels and a second desired compensation voltage for the reflective sub-pixels; deriving a common compensation voltage from said first desired compensation voltage and said second desired compensation voltage; and applying said common compensation voltage to both the transmissive and the reflective sub-pixels. Thus, the flicker resulting from a DC bias of the driving voltage is substantially reduced. In a preferred embodiment, the method further comprises the steps of: determining a lowest available frame frequency setting for which any remaining flicker is invisible; and setting a frame frequency at which the display is driven to said lowest available frame frequency. According to another embodiment, a backlight is manually controlled and the common compensation voltage is derived as a function of a mode of operation of the backlight. A transflective display device implementing the above methods is also disclosed.

### TECHNICAL FIELD OF THE INVENTION

This invention relates to reduction of visible flicker in a transflective display device, such as a liquid crystal display device, comprising a plurality of pixels.

### BACKGROUND ART

In a transflective display, each pixel comprises a reflective sub-pixel and a transmissive sub-pixel. These displays combine a power-saving, ambient light readable mode in bright environments with a backlit mode in dark environments. Transflective displays are used in, for example, mobile phones, electronic books, electronic organizers, PDA's, notebooks etc.

LCD display devices are usually driven by means of alternating voltages across the pixels, i.e. AC (Alternating Current) driving. Other display types such as electromechanical display types and electrophoretic display types may also be driven by alternating voltages. This is done by driving the pixels, in a first picture frame, with a positive voltage, and in a consecutive picture frame with a negative picture frame. In the following, these different picture frames will sometimes be referred to as positive and negative picture frames, respectively. Usually, the AC and frame frequencies coincide, i.e. every second picture frame is a positive frame and every other picture frame is a negative frame. It is further possible for sub-set of the pixels to have different polarities within the frame, for example alternate lines (“line inversion”), columns (“column inversion”) or even pixels (“pixel inversion”). Here also however the polarity of each pixel is in general still changed from one frame to another.

By employing AC driving of the pixels, the degeneration of the liquid crystal materials is substantially reduced. However, when using AC driving, it has been found that a parasitic DC (Direct Current) component may be produced across the layer of liquid crystal material. This is particularly the case when the pixels have an asymmetric structure. The DC component acts as an internal voltage in the pixel and affects the driving of the pixel differently in consecutive picture frames; the AC-voltage alternates between positive and negative sign, while the DC-component, having the same sign over an extended period of time, is superimposed upon the AC-voltage. Thus, the absolute voltages across a pixel in successive picture frames, for the same data, differ. This gives rise to a flicker at half the frequency of the frame frequency used. Generally a frame frequency of 50 or 60 Hz is used, which results in a 25-30 Hz flicker that is very clearly visible in the image.

Whilst alternative inversion methods are known to partially suppress the appearance of flicker, the polarity of each pixel is in general still changed from one frame to another and so here also flicker will be problematical.

In WO 99/57706, it is described how to reduce the flicker in a reflective display. To this end, the display device comprises a measuring element, e.g a dummy pixel, and means for applying a voltage to the measuring element during a selection period for measuring the variation of the voltage across the measuring element after the selection period, and means for adapting, depending on the measured voltage variation, a control voltage which is generated by the control means. The control voltage can then be applied to a common electrode of the pixels in order to cancel the internal voltage.

However, for transflective displays the above cited technique may not work. This is due to the fact that a transflective pixel has a much more complex structure than a reflective pixel. In particular, due to different physical characteristics, the internal voltage of the transmissive sub-pixels will generally differ from the internal voltage of the reflective sub-pixels. This fact, in combination with the above said measuring element only being able to measure the internal voltage of a simple reflective pixel, makes the previously known technique insufficient for solving the problems related to flicker in a transflective display device.

### SUMMARY OF THE INVENTION

It is an object of the present invention to alleviate the above-mentioned problems related to flicker in a transflective display. In particular, it is an object to provide a LCD display device, and a driving method for such, in which the visible flicker is reduced in a power efficient way. This object, and further advantages that will become apparent in the following, is achieved by the driving method specified in claim 1 and by the LCD display device specified in claim 11. The appended subclaims specifies preferred embodiments of the invention

It is realized, that, for example, a measuring element based on the same principles as the measuring elements described in aforementioned WO 99/57706, can be adapted and used for a transmissive pixel just as well as for a reflective pixel. It is furthermore realized that such a measuring element can be used to determine a desired compensation voltage for either a reflective or a transmissive sub-pixel of a transflective pixel, depending on the type of measuring element. Either a transmissive type measuring element related to the transmissive sub-pixels can be used, or a reflective type measuring element related to the reflective sub-pixels can be used. However, since the internal voltages in the two types of sub-pixels generally differ, the measurement will only be valid for the sub-pixels to which the measurement is related.

In addition to the above described measuring elements, there are many other methods suitable for sensing flicker. For example, optical measurements using photosensors can be used.

Measurements have indicated that there is at least a difference of 300 mV between the parasitic DC components, i.e. the internal voltages, for the reflective sub-pixel compared to the transmissive sub-pixel. This 300 mV difference is a result of the work function difference between the electrode materials used (for example aluminum and ITO) combined with the screening effects of ionic polarization in the liquid crystal layer and the alignment layers.

This situation is even more complicated due to illumination with UV and visible light which can temporarily decrease the 300 mV difference by 100-200 mV. As a result of this effect, the internal voltage in the reflective and transmissive sub-pixels will not only be different, the difference will generally vary over time. To overcome this problem, a solution with two measuring elements is proposed; one element related to the reflective sub-pixels and the other related to the transmissive sub-pixels. With these two measuring elements, the respective two internal voltages can be measured. Based on the internal voltages of the two sub-pixel types, a desired compensation voltage can be derived for each of the two sub-pixel types. The measuring elements and the adjustment of the driving voltage can for example be arranged in a similar fashion as is described in above-cited WO 99/57706.

The desired compensation voltage of a sub-pixel is the best suited voltage to superimpose on the AC driving voltage in order to eliminate the flicker effect resulting from the internal voltage. Basically, the desired compensation voltage can be taken to be of the same absolute value as the internal voltage, but with reversed sign. However, the superposition of a compensation voltage onto a sub-pixel might itself affect the internal voltage of the same. This effect could be taken into account when deriving the desired compensation voltage, thus altering it slightly from the above said value.

However, since the transmissive and the reflective sub-pixels in a given pixel generally have ohmic contact between each other, it is only possible to compensate the different internal voltage levels with a common compensation voltage, for example added to the common electrode of the pixel. It is, for example, possible to compensate for the internal voltage in the transmissive sub-pixel or the internal voltage in the reflective sub-pixel. However, in many cases it is preferred to compensate both internal voltages by some average value, in which case an internal voltage residual will generally remain in both sub-pixels. This approach minimizes the largest remaining residual voltage. Which ever approach is chosen, a difference between the internal voltages will generally remain.

In general, the internal voltage for all the reflective sub-pixels will be the same, and the internal voltages for the transmissive sub-pixels will be the same and different from the internal voltage for the reflective sub-pixels. However, there might be some minor differences between the internal voltages for different transmissive sub-pixels, as well as for different reflective sub-pixels. This difference could, for example, be the result of the sub-pixels being exposed to slightly different ambient light intensities. But, for the purpose of reducing flicker, the differences in the internal voltage between sub-pixels of the same type are generally small enough to be neglected. Thus, it is possible to derive a first desired compensation voltage, common to all transmissive sub-pixels, and a second desired compensation voltage, common to all reflective sub-pixels.

Furthermore, it is envisaged to use an ambient light sensor, sensing the ambient light. Based on the intensity of the ambient light, it is possible to estimate whether a viewer viewing the display perceives the displayed picture based primarily on the transmissive sub-pixels or primarily on the reflective sub-pixels. When the display is used in a dark environment, there is no flicker resulting from the reflective sub-pixels to compensate for, since the there is no ambient light to reflect, whilst when it is used in bright daylight, there is no need to compensate for flicker resulting from the transmissive sub-pixels, since the backlight does not contribute to the perceived picture under such conditions. Therefore, based on the intensity of the ambient light, it is possible to compensate only one set of sub-pixels. It is also possible to calculate the common compensation voltage based a weighted average of the two desired compensation voltages, depending on the ambient light. The ambient light sensing approach has the additional advantage of facilitating dynamic use of the backlight. That is, when the ambient light is bright enough, the backlight is switched off. Of course, this will cut down the power consumption substantially.

As a further alternative, the backlight can be controlled manually by a viewer of the display. In such case, the common compensation voltage can be calculated in dependence of the mode of operation of the backlight.

A basis for the present invention is thus the insight that two desired compensation voltages can be determined, one voltage relating to the transmissive sub-pixels and one voltage relating to the reflective sub-pixels, and that the visible flicker can be reduced substantially by applying a common compensation voltage, common to the transmissive sub-pixels and the reflective sub-pixels, based on the two desired voltages.

However, even if the above described measures indeed reduce the flicker, some flicker will typically remain due to differences in the desired voltages. Therefore, it is recognized that the remaining visible flicker can be further reduced by increasing the frame frequency. This is due to the fact that the eye is most sensitive for a flicker frequency of about 20 Hz, and is insensitive to flicker having a frequency above some critical frequency.

In transflective displays, 20 Hz flicker frequency occurs when using a frame frequency of 40 Hz. The critical flicker frequency for the human eye, above which it is not sensitive to flicker, is, depending on the modulation amplitude of the flicker, between 40 Hz and 60 Hz. If the internal voltage residual is 60 mV, it gives a flicker modulation amplitude of roughly 3%, which will be masked above 40 Hz. This can be achieved by using a frame frequency of 80 Hz. Furthermore, if the residual is as large as 300 mV, it will give rise to a flicker modulation amplitude of 15%, which will be invisible to the human eye above 60 Hz, corresponding to a frame frequency above 120 Hz. Therefore, by doubling the frame frequency from the customary 60 Hz to 120 Hz, even a severe flicker would become invisible. However, increasing the frame frequency increases the power consumption of the display considerably. Therefore, increasing the frame frequency on a general basis is not advisable.

Nonetheless, adjusting the frame frequency to further reduce the visible flicker is highly preferred in connection with the present invention. Thus, a basis for one embodiment of the invention is the further insight that the visible flicker resulting from the two internal voltages levels can be substantially reduced, in a power efficient way, by first applying a common compensation voltage, and then, if a residual visible flicker remains, compensate for it by increasing the frame frequency. Thus, both the driving voltage and the frame frequency are adjusted in dependence of the two desired compensation voltages.

The general approach for controlling both the driving voltage and the frame frequency is first to derive the two desired compensation voltages. Thereafter, a common compensation voltage, based on the desired voltages, is applied to the pixel. Finally, any remaining flicker is masked by increasing the frame frequency. In case the frequency is unnecessarily high, i.e. higher than needed to mask the flicker, it should instead be decreased. In other words, the frame frequency is always set to a lowest allowed value at which visible flicker is eliminated or reduced to a negligible amount. It should be noted, that not only the common compensation voltage could be derived from the desired voltages, also the remaining flicker could be derived as a function of the desired and the common compensation voltages. In one preferred embodiment, the frame frequency is always adjusted to be as low as possible without resulting in visible flicker. In another preferred embodiment, the frame frequency is interpolated from a look-up table containing preset frequencies related to different flicker modulation amplitude.

There are several advantages using this approach:

It is effective. In all occurring situations the flicker can be made invisible for the viewer. This is not possible with the prior art single flicker-sensor approach.

It is power efficient, by only increasing the frame frequency in situations where this is necessary, compared to an approach in which the frame frequency is permanently doubled.

It is flexible. Exposure with UV/visible light will automatically be compensated for, both during the exposure and the gradual recovery.

Since the sub-pixels of a given pixel generally are in ohmic contact with each other, it is not possible to use a common measuring element having the same structure as a transflective pixel. If a common measuring element is to be used, the ohmic contact between the reflective and the transmissive parts needs to be broken. A more convenient solution is to use separate measuring elements; one element relating to the transmissive sub-pixel and one element relating to the reflective sub-pixel. The measuring elements can be designed to give rise to the same internal voltages as their corresponding sub-pixels. For the measuring elements to give as accurate measuring values as possible, it is preferred to position them such that they are exposed to the same intensity of ambient light as the pixels they are intended to model. Preferably, they should be exposed to the same intensity of backlight as well. These conditions are preferred in order to have the measuring elements model the sub-pixels as closely as possible. It is envisaged to use a single measuring element of each type as well as a set of element of each type. While implementing single elements might be the most cost effective, a set of elements is likely to give better measurements. They can for example be distributed around the display to give a more representative measure of the influence of the ambient light.

Furthermore, the application of a compensation voltage as well as the alteration of the frame frequency might itself affect the internal voltages of the sub-pixels. Even though these effects are small, it is of course possible to take them into account when deriving the compensation voltages as well as when determining the lowest available frame frequency setting.

The driving of the measuring element can for example be performed in a similar way as described in previously cited WO 99/57706, with the difference however that there are two sets of elements to be driven. It is however also possible to use other types of measuring elements, for example based on optical photosensors.

The invention is applicable to display devices of the passive as well as the active types. It should furthermore be understood that the invention is equally applicable to all types of inversion schemes.

Thus, according to one aspect of the invention, a driving method for a transflective liquid crystal device is provided, which substantially reduces the flicker resulting from internal voltages in the sub-pixels. The method comprises the steps of:

Determining a first desired compensation voltage for the transmissive sub-pixels and a second desired compensation voltage for the reflective sub-pixels. This is preferably done by utilizing measuring elements, which simulates the driving conditions for the sub-pixels and outputs signals indicative of their internal voltages. The desired compensation voltages can then be determined based on said signals.

Deriving a common compensation voltage from said desired compensation voltages. The common compensation voltage is preferably set to be perceptually the most flicker reducing voltage when superimposed on the AC driving voltage.

Applying said common compensation voltage to both the transmissive and the reflective sub-pixels. This can e achieved in various ways, all of which result in the compensation voltage being superimposed on the driving voltage.

In one preferred embodiment, the frame frequency is adjusted as well. This is achieved by first determining a lowest available frame frequency setting for which any remaining flicker is not disturbing to the human eye, and then setting the frame frequency to said lowest available frame frequency. This embodiment provides a driving method, which eliminates visible flicker, while the power consumption is kept low by not using an unnecessarily high frame frequency setting.

According to another aspect, the invention provides a transflective display device, such as a liquid crystal display device, arranged to emit a flicker free picture. The device comprises a plurality of pixels, each pixel comprising a reflective sub-pixel and a transmissive sub-pixel, and driver circuitry, arranged to drive the pixels. Here, driver circuitry should be understood to comprise any means necessary to drive and control the pixels of the display. Means are provided for determining a first desired compensation voltage for the transmissive sub-pixels and a second desired compensation voltage for the reflective sub-pixel. Preferably, the means for determining the desired compensation voltages comprise a transmissive and a reflective flicker sensor, arranged to determine the first and the second desired compensations voltages, respectively. Also provided are means for determining a common compensation voltage from the first and the second desired compensation voltages. This could for example be implemented in the driver circuitry. The driver circuitry is furthermore arranged to apply said common compensation voltage to both the transmissive and the reflective sub-pixels. Alternative display devices, which can be advantageously driven by the described driving methods, are electromechanical display types and electrophoretic display types.

In the currently most preferred embodiment, the display device has a predefined set of available frame frequency settings and comprises means for determining a lowest available frame frequency setting for which flicker is not disturbing, and the driver circuitry is arranged to set the frame frequency to said lowest available frame frequency setting.

### BRIEF DESCRIPTION OF THE DRAWINGS

The invention will now be described in more detail, with reference to the accompanying drawings on which:

FIG. 1 is a schematic view of a display device 100 according to the invention, on which a portion of the display 101 is enlarged;

FIG. 2 is a schematic cross section of a transflective pixel 200, having a reflective and a transmissive sub-pixel 210, 220; and

FIGS. 3-5 are schematic flow charts illustrating various embodiments of the inventive, flicker reducing method.

### DETAILED DESCRIPTION OF PREFERRED EMBODIMENTS

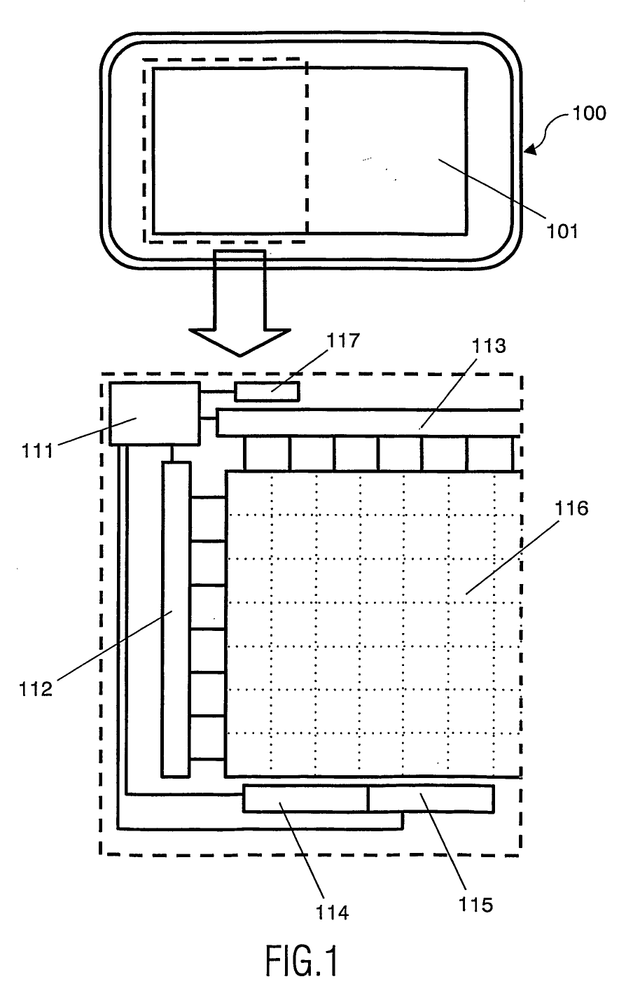

One preferred embodiment of the present invention is schematically illustrated in FIG. 1, where a transflective display device 100, and an enlarged portion of its display 101 is depicted. The display comprises a web or matrix of transflective pixels, 116, each comprising a transflective sub-pixel and a reflective sub-pixel, which are controlled by electrical circuitry 111 and driven by driver circuitry 112, 113. The driver circuitry 112, 113 comprises a data driver 113 and a row driver 112. The display device 100 further comprises first and second measuring elements, 114, 115. The first measuring element 114 is arranged to output a signal indicative of the internal voltage in the transmissive sub-pixels, the second measuring element 115 is arranged to output a signal indicative of the internal voltage in the reflective sub-pixels. The display device 100 furthermore comprises sensor means 117 for sensing the intensity of ambient light. In an alternative embodiment, in which the backlight is manually controllable, the sensor means 117 is replaced by means for determining the activation of the backlight.

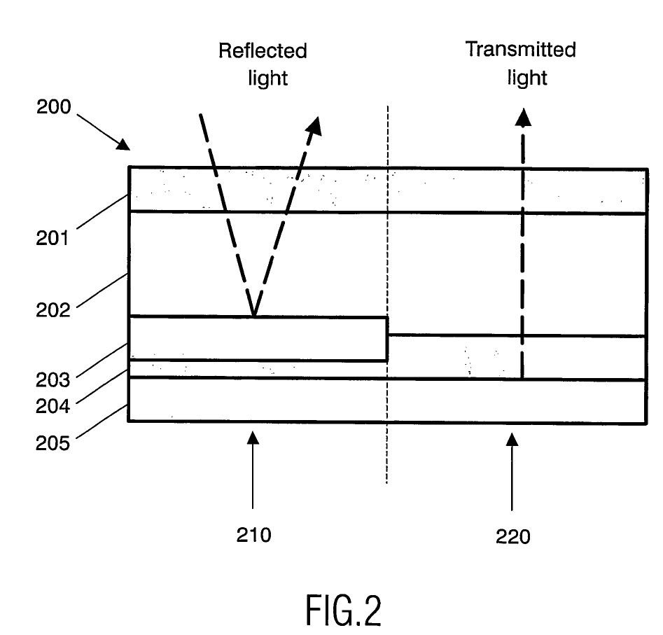

FIG. 2 schematically illustrates a cross section of a transflective pixel 200, comprising a reflective sub-pixel 210 and a transmissive sub-pixel 220. The pixel 200 comprises a layer of liquid crystal 202, common to both sub-pixels 210, 220. The liquid crystal layer is sandwiched between a first electrode 201 and a second electrode. The first electrode 201 is transmissive and common to both sub-pixels 210, 220. The second electrode comprises two portions, one reflective portion 203 defining the reflective sub-pixel 210 and one transmissive portion 204 defining the transmissive sub-pixel 220. Thus, the second electrode comprises a transmissive electrode, of which a portion is covered by a reflective electrode layer, making up the reflective portion 203, and of which another portion is making up the transmissive portion 204. The pixel furthermore comprises a backlight arrangement 205. By applying a voltage between the first electrode 201 and the second electrode, the intensity of the light passing through the layer 202 is modulated such that the pixel assumes a certain brightness. If furthermore the display incorporates a color filter (not shown) light of a desired color can be emitted from the display 101. The light passing through the liquid crystal layer 202 can either origin from ambient light, impinging upon the reflective portion 203 of the second electrode, or from the backlight, entering the liquid crystal layer 202 via the transmissive portion 204 of the second electrode, as is illustrated by the broken arrows in the figure.

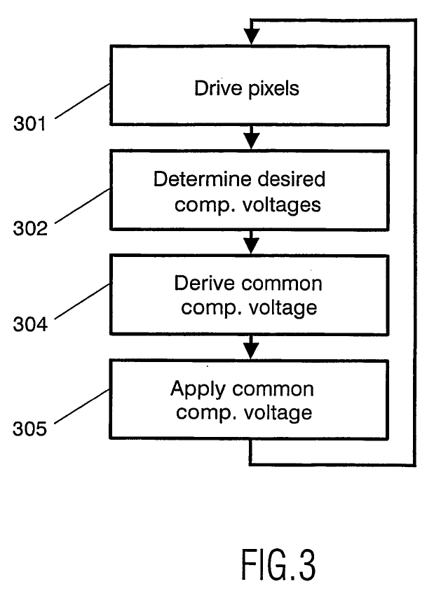

In one embodiment of the invention, a flicker reducing driving method for driving transflective display devices is provided. An embodiment thereof is illustrated by the flow chart in FIG. 3. According to this embodiment, the pixels 200 are driven 301 by an alternating voltage. While driving the pixels, a first and a second desirable compensation voltage is determined 302 for the transmissive and the reflective sub-pixels 220, 210, respectively. The desired voltages are preferably based on estimates of the internal voltages in the sub-pixels 210, 220, although other alternatives are feasible as well. Estimates based on the driving conditions or the history of operation of the display device are two such alternatives. However, in the most preferred embodiment, the estimates are based on measurements made by means of measuring elements 114, 115.

After having determined 302 the desired voltages, a common compensation voltage is derived 304, as a function of the desired voltages. The common voltage is selected as the most suitable voltage to superimpose on the alternating driving voltage to reduce the flicker resulting from the internal voltages in the sub-pixels 210, 220. It can, for example, be either one of the desired voltages, or an average thereof. When the common compensation voltage has been derived 304, it is applied 305 to the pixels. Here, to apply should be understood as any measure resulting in the compensation voltage being superimposed on the alternating driving voltage of the pixels. Given the state of the art in general, and the disclosure in WO 99/57706 in particular, the skilled man is able to implement this in many different ways. The compensation voltage can, for example, be applied to the first electrode 113, which is common to both sub-pixels 210, 220 of each pixel 200.

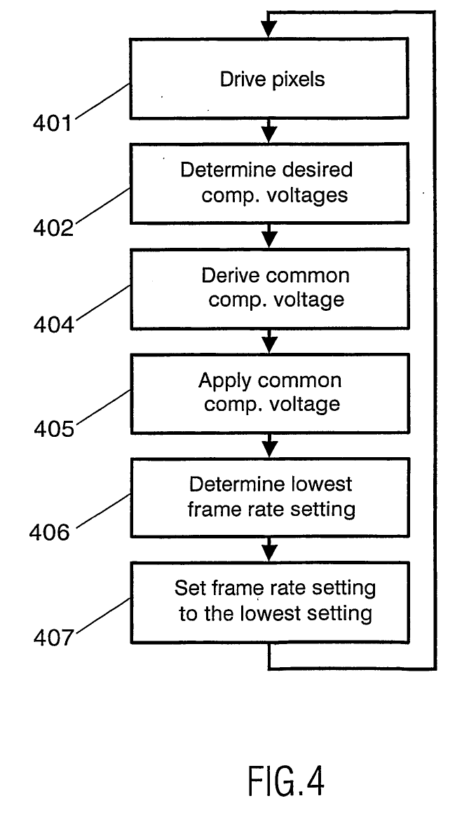

A second embodiment of the inventive method is disclosed by the block diagram of FIG. 4. Just as in the previous embodiment, the pixels are driven 401, the desired compensation voltages are determined 402 and a common compensation voltage is derived 404 and applied 405 to the pixels.

However, since the common compensation voltage may not, in the general case, eliminate the flicker completely, a lowest available frame frequency setting for which any remaining flicker is invisible to the human eye is determined 406. The larger the amplitude of the remaining flicker, the higher the frame frequency needed to mask the remaining flicker. The available frame frequency settings could either be a continuous set of frame frequency settings, or a discrete set of frame frequency settings. A discrete set of frame frequency settings can for example be listed in a look-up table, stored in the electrical circuitry 111 of the display device. When the lowest available frame frequency setting has been determined, the frame frequency setting of the display device is set 407 to said lowest available frame frequency setting.

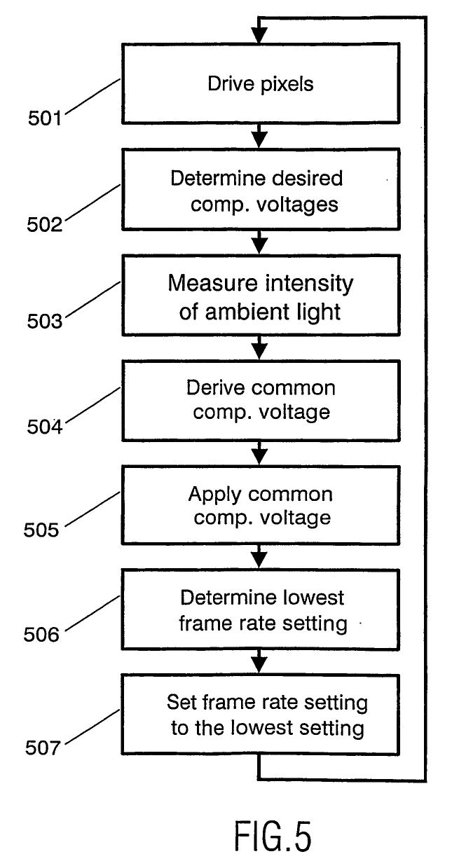

A still further embodiment of the inventive method is disclosed by the block diagram in FIG. 5. According to this embodiment, each step carried out in the embodiment described with reference to FIG. 4 is carried out, the steps now being designated 501, 502, 504-507. However, the additional step of measuring 503 the intensity of the ambient light surrounding the display device is introduced. Based on the result of this measurement, the common compensation voltage is derived 504 not only as a function of the desired compensation voltages, but also as a function of the intensity of the ambient light. In an alternative embodiment, in which the backlight is manually controllable, the step of measuring 503 the intensity of the ambient light is replaced by the step of determining the mode of operation of the backlight. According to this embodiment, the common compensation voltage is derived 504 as a function of the mode of operation of the backlight.

The positioning and addressing of the measuring elements 114, 115, can be embodied in a similar fashion as proposed in aforementioned WO 99/57706, with the remark that both sensors should preferably be placed in the visible part of the display, which is exposed to ambient illumination.

One way of deriving the common compensation voltage is to calculate the average of the desired compensation voltages for the reflective and transmissive sub-pixels, respectively. The optimal frame frequency can be derived from the difference between the desired compensation voltages for the reflective sub-pixels and the transmissive sub-pixels by means of a look-up table, as for instance:

| ΔV | F | |
|---|---|---|
| <50 mV | 60 | Hz |
| 60 mV | 80 | Hz |
| 150 mV | 100 | Hz |
| >300 mV | 120 | Hz |

According to one embodiment, the backlight is controlled manually by a viewer of the display. In this embodiment, the common compensation voltage can be calculated as the weighted average of the desired compensation voltage for the reflective sub-pixels and the desired compensation voltage for the transmissive sub-pixel, depending on the activation of the backlight. For instance, if the backlight is on, this means that the display is probably used in dark ambient lightning conditions; therefore most of the image perceived by the viewer originates from the transmissive sub-pixels, and thus, the common compensation voltage can be set closer to the desired compensation voltage for the transmissive sub-pixel. Alternatively, in daylight conditions when the backlight is not activated, the common compensation voltage can be set equal or close to the desired compensation voltage for the reflective sub-pixel.

If the common compensation voltage is set taking the backlight into account, the optimal frame frequency can be calculated from a modified look-up table, in which lower frame frequencies are possible. For instance, if the backlight is switched off for use in daylight conditions, the common compensation voltage can be set according to the desired compensation voltage for the reflective sub-pixels and the frame frequency can be kept as low as 60-80 Hz, even if the desired voltage for the transmissive sub-pixels differs from desired compensation voltage for the reflective sub-pixels by 300 mV. In this situation no flicker will be visible, while at the same time the power is used efficiently.

If an ambient light sensor is used, the backlight intensity can be set automatically according to the light conditions, and the common compensation voltage can be calculated as the weighted average of the desired compensation voltage for the reflective sub-pixels and the desired compensation voltage for the transmissive sub-pixels, with the ambient light intensity as a weight factor. The optimal frame frequency can be calculated from an extended look-up table, for example according to the following table:

| ΔV | | F (low lux) | F (med lux) | | F (high lux) |
|---|---|---|---|---|---|
| <50 | mV | 60 Hz | 60 | Hz | 60 Hz |
| 60 | mV | 70 Hz | 80 | Hz | 70 Hz |
| 150 | mV | 75 Hz | 100 | Hz | 75 Hz |
| >300 | mV | 80 Hz | 120 | Hz | 80 Hz |

This is a very power efficient solution, since it utilizes both the backlight efficiently and the frame frequency. Of course, it is also possible to make the ambient light sensor control the backlight, e.g. turn the backlight off when the ambient light is bright enough.

As for the frame frequency implementation, standard frequency enhancements algorithms can be used. For example, for providing a 70 Hz output signal from a 60 Hz input signal a standard available frame memory is used to repeat every 6^{th} frame. Alternative frequency scaling algorithms can also be utilized.

It is also envisaged to reduce the perceived flicker by altering the inversion scheme. This can be done instead of or in combination with frequency adjustments. For example, frame inversion can be used to compensate for small differences in the desired compensation voltages, line inversion can be used to compensate for medium differences, dot inversion can be used to compensate for high differences, and dot inversion in combination with frequency increments can be used for very high differences.

In conclusion, a method of reducing visible flicker in a transflective display device, having a plurality of pixels, each pixel comprising a transmissive sub-pixel and a reflective sub-pixel, is disclosed. The method comprises the steps of: driving the pixels with an alternating voltage; determining a first desired compensation voltage for the transmissive sub-pixels and a second desired compensation voltage for the reflective sub-pixels; deriving a common compensation voltage from said first desired compensation voltage and said second desired compensation voltage; and applying said common compensation voltage to both the transmissive and the reflective sub-pixels. Thus, the flicker resulting from a DC bias of the driving voltage is substantially reduced.

In a preferred embodiment, the method further comprises the steps of: determining a lowest available frame frequency setting for which any remaining flicker is invisible; and setting a frame frequency at which the display is driven to said lowest available frame frequency. According to another embodiment, a backlight is manually controlled and the common compensation voltage is derived as a function of a mode of operation of the backlight.

A transflective display device implementing the above methods is also disclosed.

1. A method of reducing visible flicker in a transflective display device having a plurality of pixels, each pixel comprising a transmissive sub-pixel and a reflective sub-pixel, comprising the steps of:
driving the pixels with an alternating voltage,
determining a first desired compensation voltage for reducing the optical flicker of the transmissive sub-pixels and a second desired compensation voltage for reducing the optical flicker of the reflective sub-pixels;
deriving a common compensation voltage from said first desired compensation voltage and said second desired compensation voltage; and
applying said common compensation voltage to both the transmissive and the reflective sub-pixels.

2. A method as claimed in claim 1, further comprising the steps of:
determining a lowest available frame frequency setting for which any remaining flicker is invisible; and
setting a frame frequency at which the display is driven to said lowest available frame frequency setting.

3. A method as claimed in claim 2, wherein the lowest available frame frequency setting is selected from a discrete set of frame frequency settings listed in a look-up table.

4. A method as claimed in claim 2, further comprising the step of measuring the intensity of ambient light surrounding the display, and wherein the lowest available frame frequency setting is derived as a function of the intensity of the ambient light.

5. A method as claimed in claim 1, wherein the step of determining the first and the second desired compensation voltages comprises the steps of
driving a first flicker sensor related to the transmissive sub-pixels and a second flicker sensor related to the reflective sub-pixels; and
determining the first desired compensation voltage from the output of the first flicker sensor and determining the second desired compensation voltage from the output of the second flicker sensor.

6. A method as claimed in claim 1, further comprising the step of measuring the intensity of ambient light surrounding the display, wherein the common compensation voltage is derived as a function of the intensity of the ambient light.

7. A method as claimed in claim 1, wherein the display device is illuminated by means of a backlight, and wherein the common compensation voltage is derived as a function of a mode of operation of the backlight.

8. A method as claimed in claim 7, further comprising the steps of measuring the intensity of ambient light surrounding the display and selecting the mode of operation of the backlight as a function of said intensity of ambient light.

9. A method as claimed in claim 1, wherein the common compensation voltage is derived as the average of the first desired compensation voltage and the second desired compensation voltage.

10. A method as claimed in claim 1, further comprising the step of altering a data inversion scheme, according to which scheme the pixels are driven, in dependence of a remaining optical flicker.

11. A transflective display device comprising a plurality of pixels, each pixel comprising a transmissive sub-pixel and a reflective sub-pixel, the device further comprising electrical circuitry and driver circuitry, arranged to drive the pixels with an alternating voltage,
characterized in that:
means are provided for determining a first desired compensation voltage for reducing the optical flicker of the transmissive sub-pixels and a second desired compensation voltage for reducing the optical flicker of the reflective sub-pixels;
the electrical circuitry is arranged to derive a common compensation voltage from said first desired compensation voltage and said second desired compensation voltage;
and in that
the driver circuitry is arranged to apply said common compensation voltage to both the transmissive sub-pixels and the reflective sub-pixels.

12. A display device as claimed in claim 11, the display device being a transflective liquid crystal display device.

13. A display device as claimed in claim 11, having a predefined set of available frame frequency settings and in which the electrical circuitry is arranged to determine a lowest available frame frequency setting for which flicker is invisible, and to set a frame frequency to said lowest available frame frequency setting.

14. A display device as claimed in claim 13, further comprising a sensor for measuring an intensity of ambient light surrounding the display, and wherein the electrical circuitry is arranged to determine the lowest available frame frequency setting for which flicker is invisible as a function of the intensity of the ambient light.

15. A display device as claimed in claim 11, comprising:
a transmissive flicker sensor, arranged to determine a first internal voltage; and
a reflective flicker sensor, arranged to determine a second internal voltage, the electrical circuitry being arranged to derive the first desired compensation voltage from the first internal voltage and the second desired compensation voltage from the second internal voltage.

16. A display device as claimed in claim 11, further comprising a common electrode, common to each transmissive and reflective sub-pixel, wherein driver circuitry is arranged to apply the common compensation voltage to said common electrode.

17. A display device as claimed in claim 11, further comprising a sensor for measuring the intensity of ambient light surrounding the display, wherein the electrical circuitry is arranged to derive the common compensation voltage as a function of the intensity of the ambient light.

18. A display device as claimed in claim 12, further comprising a backlight, wherein the electrical circuitry is arranged to derive the common compensation voltage as a function of a mode of operation of the backlight.

19. A display device according to claim 18, further comprising a sensor for measuring the intensity of ambient light surrounding the display, and wherein the electrical circuitry is arranged to select the mode of operation of the backlight as a function the intensity of ambient light.
